(19) United States
(12) Patent Application Publication
(10) Pub. No.: US 2022/0277312 A1
(43) Pub. Date: Sep. 1, 2022

(54) DATA PROCESSING SYSTEM WITH MESSAGE FORMATTING

(71) Applicant: Visa International Service Association, San Francisco, CA (US)

(72) Inventors: Shoon Ping Wong, Centennial, CO (US); Kobus Meyer, Morrison, CO (US); Sharon Trujillo-Vialpando, Parker, CO (US); Sarah Helgeson, Denver, CO (US); Dawn Campbell, Littleton, CO (US); Justin Monk, Higlands Ranch, CO (US)

(21) Appl. No.: 17/187,054

(22) Filed: Feb. 26, 2021

(51) Int. Cl. G06Q 20/42; G06Q 20/38; G06Q 20/40

(52) U.S. Cl. CPC G06Q 20/42; G06Q 20/386; G06Q 20/4016

(57) ABSTRACT

A method is disclosed and includes receiving, from a network computer, an authorization request message in a first data format for an interaction and converting the authorization request message in a first data format to a second data format. The method also includes transmitting the authorization request message in the second data format to a processing system comprising plurality of processing modules. The processing system uses the plurality of processing modules to process the data in the authorization request message in the second data format.

### CROSS-REFERENCE TO RELATED APPLICATIONS

None.

### BACKGROUND

Services for processing certain types of interactions are known. For example, a person attempting to use an access badge may scan an access badge at a card reader. Data from the card may be run through an algorithm to determine if the card is legitimate and that the user may access a desired location. In another example, a user may use a payment card to purchase something. The user may tap the payment card to a card reader and a fraud analysis algorithm may be run on the data from the payment card to produce a fraud score. The fraud score can be used to determine if the user is able to obtain the desired good or service.

One problem with existing systems is that they cannot be universally used. For example, in the above example relating to the payment transaction, the fraud analysis algorithm is useable only in a particular processing system. Other external parties are unable to use the fraud algorithm, thereby limiting the potential use of the fraud algorithm.

Embodiments of the invention address these and other problems.

### SUMMARY

One embodiment includes a method comprising receiving, by a gateway computer from a network computer, an authorization request message in a first data format for an interaction, converting, by the gateway computer, the authorization request message in a first data format to a second data format, and transmitting, by the gateway computer, the authorization request message in the second data format to a processing system comprising plurality of processing modules, wherein the processing system uses the plurality of processing modules to process the data in the authorization request message in the second data format.

Another embodiment of the invention includes a gateway computer comprising: a processor; and a computer-readable medium coupled to the processor, the computer-readable medium comprising code, executable by the processor, to cause the gateway computer to: receive, from a network computer, an authorization request message in a first data format for an interaction; convert the authorization request message in a first data format to a second data format; and transmit the authorization request message in the second data format to a processing system comprising plurality of processing modules, wherein the processing system uses the plurality of processing modules to process the data in the authorization request message in the second data format.

A further embodiment of the invention includes a method comprising: receiving, by a processing system, from a gateway computer, an authorization request message in a second data format for an interaction, the authorization request message having been previously converted, by the gateway computer, from a first data format to the second data format; processing, by the processing system, data in the authorization request message in the second data format using a plurality of processing modules to include output data; and transmitting, by the processing system, the authorization request message including the output data in the second data format.

These and other embodiments of the invention are described in further detail below.

### BRIEF DESCRIPTION OF THE DRAWINGS

FIG. 1 shows a block diagram of a system along with a flow diagram overlaid on the system diagram.

FIG. 2 shows a block diagram of an exemplary gateway computer according to embodiments.

FIG. 3 shows a block diagram of an exemplary processing system according to embodiments.

FIG. 4 shows a block diagram an authorizing entity computer according to embodiments.

### DETAILED DESCRIPTION

Prior to discussing the figures of the disclosure, some terms can be described in further detail.

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), and the like. An access device may use any suitable contact or contactless mode of operation to send or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

An “authorization request message” may be an electronic message that requests authorization for a transaction. In some embodiments, an authorization request message is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization.

A “format” may be a standard in which items are presented for recognition by a human or system. For example, a “data format” may be a format which is recognizable by a system or a component.

A “gateway computer” may be a computer which acts as an entry point to another device or system.

An “interaction” may be any action which involves two or more entities. In some embodiments, an interaction may include a transaction such as an access transaction to obtain access to a location, a payment transaction, or a transaction to retrieve data from a remote location.

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “network computer” may be a computer that operates in a data network such as a processing network (e.g., a payment processing network) or a communications network.

“Parsing” may refer to an act of analyzing a set or string of data.

A “processing system” may include a system that can support and deliver data services. A processing system can include two or more data processing modules, which can operate independently of each other to process data. In cases where the processing system provides data services related to transactions, the processing system may parse data to generate transaction processing data or transaction processing messages.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “transport computer” may be an entity or system which acts as an intermediary between a resource provider computer and a network computer as discussed herein. In various embodiments, a transport computer is configured to route information on-site at a resource provider computer to an off-site network computer.

A “user device” may be any suitable device that is operated by a user. User devices may be in any suitable form. Some examples of user devices include cellular phones, PDAs, personal computers (PCs), tablet computers, and the like. In some embodiments, where a user device is a mobile device, the mobile device may include a display, a memory, a processor, a computer-readable medium, and any other suitable component. The user device may also be a payment device (e.g., a credit, debit, or prepaid card) or an access device (e.g., an access badge) in some instances.

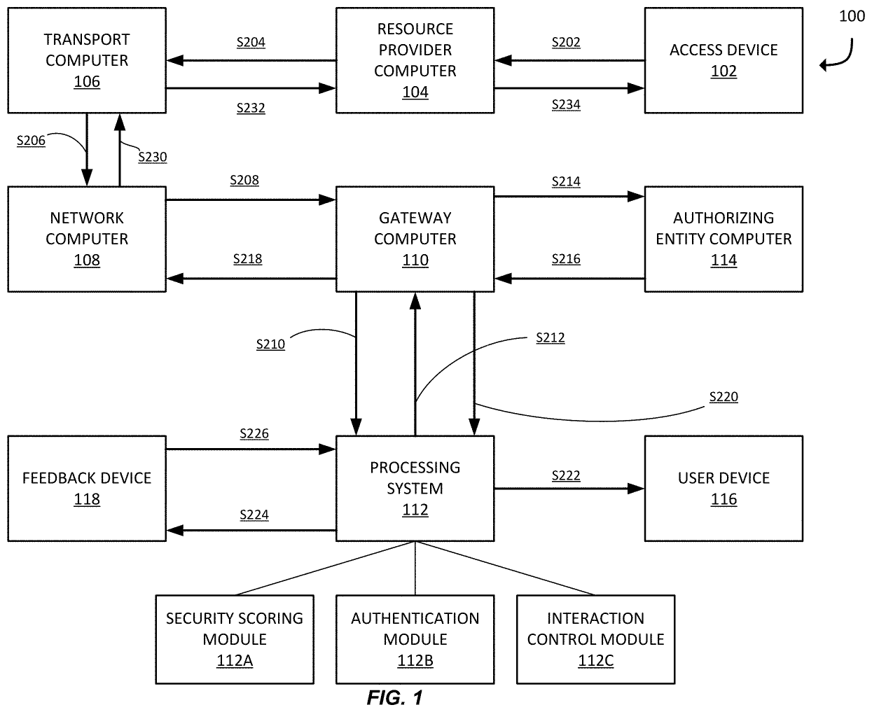

FIG. 1 shows a system 100 that comprises gateway computer 110 in communication with a network computer 108. The network computer 108 may be a switch that switches messages between various authorizing entity computers and transport computers. In some embodiments, there can be many different network computers operated by different entities providing messages to and receiving messages from the gateway computer 110.

The network computer 108 may also be in communication with a resource provider computer 104 via a transport computer 106. An access device 102 may interact with the resource provider computer 104 during an interaction. The access device 102 and the resource provider computer 104 may be operated by a single resource provider (e.g., a single merchant) in some embodiments. The access device 102 may be, for example, a POS terminal and the resource provider computer 104 may be a backend computer that processes or routes data from the access device 102.

The gateway computer 110 may also be in communication with an authorizing entity computer 114, and a processing system 112. The processing system 112 may be in communication with a network computer 108 and an authorizing entity computer 114 via a gateway computer 110.

The gateway computer 110 may receive an authorization request message from the access device 102 via the resource provider computer 104, the transport computer 106, and the network computer 108. The gateway computer 110 may parse the authorization request message and format the data in a second data format so that it can be processed in parallel by various processing modules in or accessible to the processing system 112. Such modules may include a security scoring module 112A, an authentication module 112B, and an interaction control module 112C.

Feedback device 118 may be used to train modules of processing system 112. According to various embodiments, feedback device 118 may intake performance data from processing modules 112A, 112B, 112C or configuration data from authorizing entity computer 114 directly or indirectly. Feedback device 118 may modify received data or cause data or entities within processing system 112 to be modified in order to change processing functions in processing system 112 or subsystems therein. In various embodiments, feedback system 118 implements a machine learning system for automatically modifying the functions of the processing system 112.

For simplicity of illustration, a certain number of components are shown in FIG. 1. It is understood, however, that embodiments of the invention may include more or less components than the components that are illustrated.

Messages between the devices in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

Methods according to embodiments can be described with reference to FIG. 1.

At step S202, the access device 102 may generate and transmit an authorization request message in a first format to the resource provider computer 104 after the access device receives a credential from a user. In some embodiments, the first format may be an ISO 8583 data format. The credential may be stored on a user device (e.g., an access card or payment card) that may be tapped or inserted into the access device 102. In other embodiments, the user may simply provide the credential to the access device 102 by entering it directly into the access device 102, or entering it through a connected user device.

At step S204, after the resource provider computer 104 receives the authorization request message, the resource provider computer 104 sends the authorization request message to the transport computer 106.

At step S206, after transport computer 106 receives the authorization request message from the resource provider computer 104, the transport computer 106 sends the authorization request message to the network computer 108.

At step S208, after network computer 108 receives the authorization request message from the transport computer 106, the network computer 108 may determine the appropriate gateway computer 110 for routing. Once this is determined, the network computer 108 can transmit the authorization request message in the first format to the gateway computer 110. Although one network computer is illustrated in FIG. 1, there can be many network computers sending authorization request messages in different data formats to the gateway computer 110. The gateway computer 110 can resolve all of those authorization request messages into a single common format so that they can all be processed, regardless of the data format of the messages incoming from the network computers.

At step S210, after receiving the authorization request message in the first format, the gateway computer 110 may convert the authorization request message in the first data format to an authorization request message in a second data format. The gateway computer 110 may then send the authorization request message in the second data format to the processing system 112. Examples of second data formats may be XML, JSON, CSV, etc. As shown in FIG. 1, the processing system 112 may comprise a number of software modules including, but not limited to a security scoring module 112A, an authentication module 1126 and an interaction control module 112C. At least one of these modules 112A, 112B, 112C may receive all of or portions of the authorization request message in the second data format.

The processing system 112 can process the data in the authorization request message to supplement, augment, or improve the data in the authorization request message, before it is sent to the authorizing entity computer 114 for approval.

For example, the security scoring module 112A, in conjunction with a data processor, can score the current transaction based upon data in the authorization request message, and also based upon data external to the transaction. For example, the transaction may be scored using the account identifier, an identification of the resource provider, and the transaction amount associated with the transaction. The transaction may then be scored using a scoring algorithm to produce a risk score. This risk score can be useful in making a decision to authorize or decline the transaction if the gateway computer 110 is responding to the transaction authorization request message on behalf of the authorizing entity computer 114. Alternatively, the risk score can be incorporated into the authorization request message that will be sent to the authorizing entity computer 114. The risk score can be used by the authorizing entity computer 114 to decide whether or not to authorize the transaction.

The authentication module 112B and a data processor may perform authentication services. For example, the authentication module 112B and a data processor may perform authentication processing related to the user conducting the transaction of the user device that is being used by the user to conduct the transaction. For instance, the authentication module 112B and the processor could send a transaction alert to a mobile phone operated by the user conducting the transaction to confirm their entity. In other embodiments, the authentication module 112b and the processor can cryptographically verify cryptograms in the authorization request message that may have been generated by the user's user device or from data entered by the user to authenticate the user and/or the user device conducting the transactions.

The interaction control module 112C and a data processor may perform control operations on the transaction. For example, the interaction control module 112C and the data processor can store certain parameters that can be used to control the authorization of transactions. Such parameters may relates to the time and/or place of a transaction or a transaction amount. For instance, the interaction control module 112C may have rules which indicate that transactions over $10,000 during non-business hours should be declined, unless the user has pre-approved of the authorization. In this example, if the transaction exceeds these parameters, the interaction control module 112 may provide an indication of this in the authorization request message that is sent to the authorizing entity computer 114.

Although three processing modules 112A, 112B, 112C are illustrated, it is noted that other types of processing modules may be present, and each processing module may process data from the authorization request message in the second format in parallel.

At step S212, after the processing modules 112A, 112B, 112C have performed their processing on the data in the authorization request message, the processing system 112 include the outputs from these modules 112A, 112B, 112C in the authorization request message in the second format. The authorization request message in the second format may be transmitted to the gateway computer 110.

At step S214, after receiving the authorization request message in the second format, the gateway computer 110 may convert the authorization request message back to the first format. The gateway computer 110 may then send the authorization request message in the first format to the authorizing entity computer 114. After receiving the authorization request message, the authorizing entity computer 114 may determine if the transaction should or should not be authorized. The authorizing entity computer 114 may take into account data that was provided by the processing modules 112A, 1126, 112C, as well as other data (e.g., an account balance of an account held by an authorizing entity operating the authorizing entity computer 114).

In an embodiment, gateway 110 may standardize incoming authorization request messages into a standard format before sending the authorization request messages to authorizing entity computer 114. For example, gateway 110 may maintain an up-to-date repository of regulatory formats for incoming authorization request messages. Gateway 110 may then convert incoming authorization request messages of multiple formats, including those in a contemporary regulatory format, into a single standardized format for receipt by authorizing entity computer 114. In an additional embodiment, authorizing entity computer 114 receives authorization request messages from gateway 110 in a minimalized format, which is a format that conveys only a minimum amount of information necessary for authorizing entity computer 114 to determine if the transaction should or should not be authorized.

At step S216, authorizing entity computer 114 may send an authorization response message in the first format to gateway computer 110. The authorization response message may comprise an approval or declination indicator to indicate whether or not the transaction was approved or declined by the authorizing entity computer 114.

In an embodiment, gateway computer 110 may perform an approval or declination determination on behalf of the authorizing entity computer 114. For example, the gateway computer 110 may parse the authorization request message in the second format once it is received at step S214. The gateway computer 110 may then determine whether or not the transaction should be approved or declined without input from the authorizing entity computer 114. Gateway computer 110 may then accept or decline the transaction and generate an authorization response message. In an additional embodiment, gateway computer 110 may determine to accept the transaction, decline the transaction, or send the authorization request message in the first format to the authorizing entity computer 114 for further determination.

At step S218, gateway computer 110 may send the authorization response message to the network computer 108. The network computer 108 may then determine an appropriate transport computer 106 to which the authorization response message will be routed. After making this determination, the network computer may then transmit the authorization response message in the first format to the access device via the transport computer and the resource provider computer 104 as in steps S230, S232, and S234.

At the end of the day or at any other suitable period of time, a clearing and settlement processing can take place between the transport computer 106, the network computer 108, and the authorizing entity computer 114 to settle the transaction along with other transactions.

At step S220, after receiving the authorization response message in step S216, the gateway computer 110 can convert the authorization response message to the second data format, and may send the authorization response message in the second data format to the processing system 112. The authorization or declination indictor and other data may be used by the modules 112A, 112B, 112C as training data to improve the modules for the processing of subsequent authorization request messages.

At step S222, processing system 112 may optionally send a message with a transaction authorization result to the user device 116.

At step S224, processing system 112 may send processing module training data to the feedback device 118. Feedback device 118 may use one or more machine learning algorithms to receive raw transaction data from the processing system 112 and transaction authorization results from the processing system 112 to train the various modules 112A, 112B, 112C so that they can process future authorization request messages more efficiently.

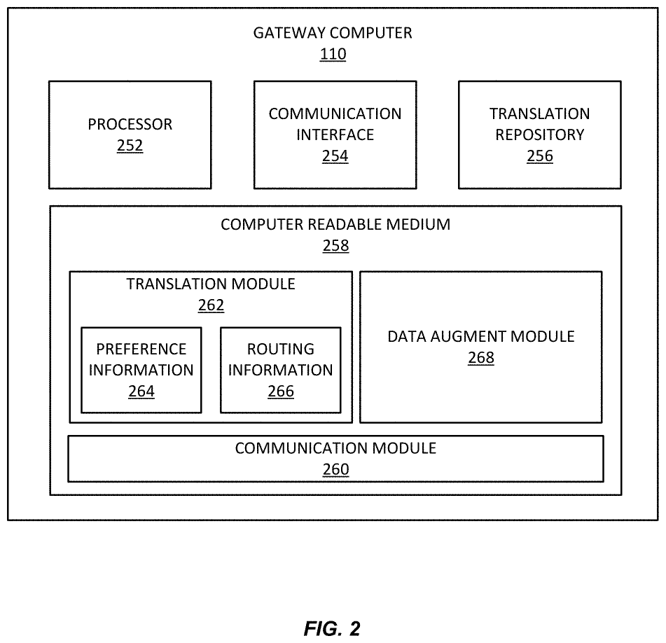

FIG. 2 shows a block diagram of components of a gateway computer 110. The gateway computer 110 may comprise a processor 252, coupled to a communication interface, a translation repository 256, and a computer readable medium 258.

The communication interface 254 may include hardware and software to allow the gateway computer 110 to interact with external devices, including through communication module 260.

The translation repository 256 may be a data storage medium which stores data that can be used to translate a message from one format to another. In some embodiments, the translation repository 256 comprises information and/or mapping data for converting data from a first format to a second format that is different than the first format, and vice-versa.

Gateway computer 110 may comprise computer readable medium 258. Computer readable medium may store code that can be executed by the processor 252 to cause the gateway computer 110 to perform a method comprising: receiving, from a network computer, an authorization request message in a first data format for an interaction; converting, by the gateway computer, the authorization request message in a first data format to a second data format; and transmitting, by the gateway computer, the authorization request message in the second data format to a processing system comprising plurality of processing modules, wherein the processing system uses the plurality of processing modules to process the data in the authorization request message in the second data format.

Computer readable medium may comprise translation module 262. Translation module 262, in conjunction with the processor 252, may translate a message with data from a first format into a second format, or vice-versa according to translation rules that may be stored in the translation repository 256. The translation module 262 may also comprise preference information 264. Preference information 264 may be instructions which specify an existing configuration for translation based on the preferences of an authorizing entity, a transaction processor, or any other suitable entity.

Translation module 262 may further comprise routing information 266. Routing information 266 may include information regarding where to route (e.g., which particular processing module to route data to) an authorization request message or data from the authorization request message.

Computer readable medium 258 may comprise data augment module 268. In various embodiments, data produced by the one or more processing modules may be added to an authorization request message before it is provided to an authorizing entity computer.

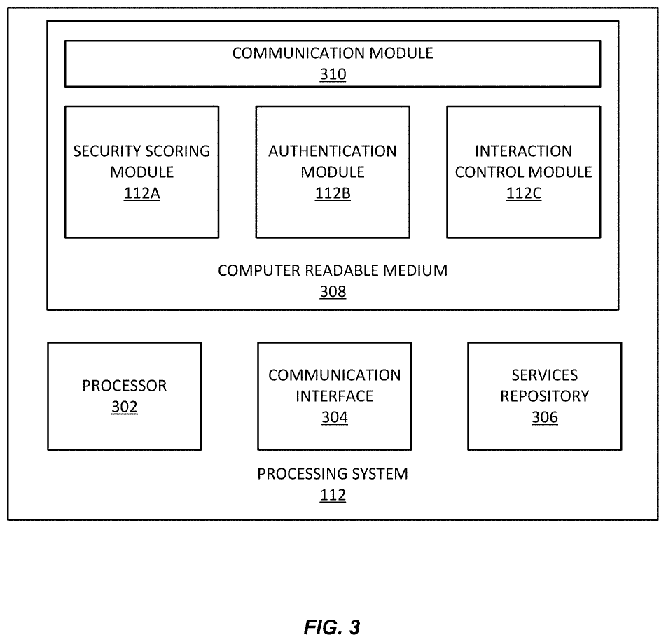

FIG. 3 shows a block diagram of components of a processing system according to embodiments. Specifically, FIG. 3 depicts various components that may be included in processing system 112. Processing system 112 may comprise processor 302, and a communication interface 304. The communication interface 304 may include hardware and software to allow the processing system 112 to interact with external devices, including through communication module 310.

Processing system 112 may comprise services repository 306. Services repository 306 may store services information. In various embodiments, services repository 306 comprises information that can be used to modify or format authorization request messages.

Processing system 112 may comprise computer readable medium 308. The computer readable medium 308 may store code that can be executed by the processor 302 to perform a method comprising receiving, from a gateway computer, an authorization request message in a first data format for an interaction, the authorization request message having been previously converted, by the gateway computer, from a second data format to the first data format, the second data format corresponding to a network computer from which the gateway computer received the authorization request message; and transmitting the authorization request message in the first data format to a plurality of processing modules, wherein the plurality of processing modules process the data in the authorization request message in the first data format.

Computer readable medium 308 may comprise a security scoring module 112A, authentication module 1126, and interaction control module 112C. These modules have been described in detail above.

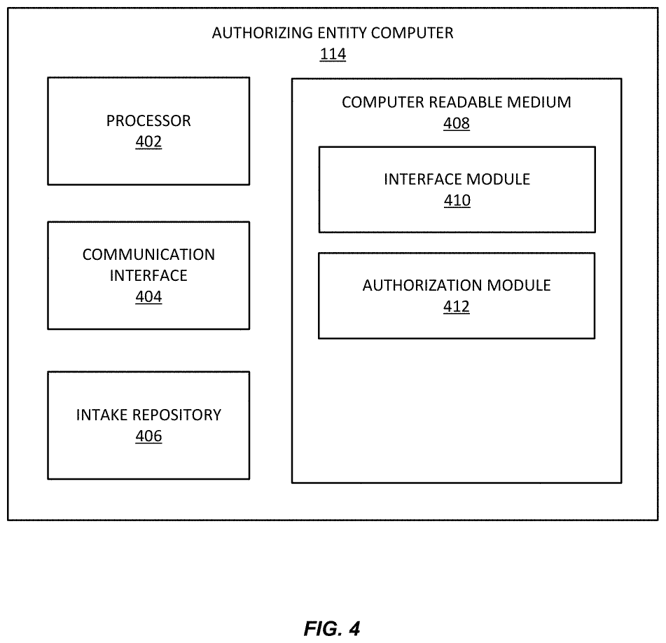

FIG. 4 shows a block diagram of an authorizing entity computer 114 according to embodiments. The authorizing entity computer 114 may comprise processor 402 and a communication interface 404.

Authorizing entity computer 114 may also comprise an intake repository 406. Intake repository 406 may be any memory, storage, repository or medium in which intake information may be stored. In various embodiments, intake repository 406 comprises information pertaining to authorization request messages or information contained therein.

Authorizing entity computer 114 may comprise computer readable medium 408. Computer readable medium may store instructions, information or code that can be executed by a processor, such as processor 402, to cause the steps and methods performable by authorizing entity computer 114 and described herein. Computer readable medium 408 may comprise interface module 410. Interface module 410 allows the authorizing entity computer 114 to communicate with a user device operated by users associated with the authorizing entity operating the authorizing entity computer.

Computer readable medium 408 may comprise an authorization module 412. The authorization module 412 and the processor 402 can determine whether to authorize or decline an authorization request message. The computer readable medium 408 may also comprise a clearing and settlement module (not shown).

The systems, apparatuses, and methods described herein have a number of advantages. As is apparent from the embodiments described above, a gateway computer according to embodiments of the invention can convert an authorization request message into a format that can be analyzed and processed by a processing system with access to a number of processing modules. As a result, different network computers may send authorization request messages in various message formats to a gateway computer, and the gateway computer can convert those authorization request messages into a common data format, and can then send them to a processing system with multiple processing modules. The processing modules may also process data from the authorization request messages in parallel, providing for faster processing of data in authorization request messages.

Although the above described embodiments specifically mention and describe payment transactions, embodiments of the invention are not limited to payment transactions. Embodiments can also be used in access transactions or transactions to access secure data.

Embodiments of the invention may utilize a computer system that may be used to implement any of the entities or components described above. The subsystems in the computer system may be interconnected via one or more system buses. Additional subsystems include a printer, keyboard, fixed disk, and monitor, which is coupled to display adapter. Peripherals and input/output (I/O) devices, which couple to I/O controller, can be connected to the computer system by any number of means known in the art, such as a serial port or Universal Serial Bus (USB) port. For example, serial port or external interface can be used to connect the computer apparatus to a network (e.g., wide area network, local area network, etc.) such as the Internet, a mouse input device, touchscreen, or a scanner. The interconnection via system bus allows the one or more processors to communicate with each subsystem and to control the execution of instructions from system memory or the fixed disk, as well as the exchange of data between subsystems.

The system memory and/or the fixed disk may embody a non-transitory computer-readable storage medium. The non-transitory computer-readable storage medium may store instructions that, when executed by the one or more processors, cause the computer system to implement the methods and flows described herein. Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of data such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired data and which can be accessed by the computer. Based on the disclosure and teachings provided herein, a person of ordinary skill in the art will appreciate other ways and/or methods to implement the various embodiments.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices and may reside on or within a single computational apparatus, and may be present on or within different computational apparatuses within a system or network

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a gateway computer from a network computer, an authorization request message in a first data format for an interaction;
converting, by the gateway computer, the authorization request message in a first data format to a second data format; and
transmitting, by the gateway computer, the authorization request message in the second data format to a processing system comprising plurality of processing modules, wherein the processing system uses the plurality of processing modules to process the data in the authorization request message in the second data format.

2. The method of claim 1, further comprising:
receiving the authorization request message in the second data format from the processing system;
converting the authorization request message in the second data format to the first data format; and
transmitting the authorization request message in the first data format to an authorizing entity computer.

3. The method of claim 1, wherein the processing system:
parses the authorization request message in the second data format, and then generates a plurality of transaction processing messages in data formats different than the first and second data formats; and
provides the plurality of transaction processing messages to the plurality of processing modules, respectively.

4. The method of claim 1, wherein the plurality of processing modules comprise a security scoring module, an interaction control module, and an authentication module.

5. The method of claim 3, further comprising:
receiving, from the plurality of processing modules, transaction processing data; and
augmenting the authorization request message with the transaction processing data.

6. The method of claim 5, wherein the transaction processing data comprises a risk score.

7. The method of claim 1, wherein the gateway computer and the processing system receive configuration data prior to the interaction.

8. The method of claim 7, wherein the configuration data defines the plurality of processing modules to process the data in the authorization request message.

9. The method of claim 1, wherein the interaction is a transaction.

10. The method of claim 9, wherein the first data format is an ISO 8583 message format.

11. A gateway computer comprising:
a processor; and
a computer-readable medium coupled to the processor, the computer-readable medium comprising code, executable by the processor, to cause the gateway computer to perform actions including:
receiving, from a network computer, an authorization request message in a first data format for an interaction;
converting the authorization request message in a first data format to a second data format; and
transmitting the authorization request message in the second data format to a processing system comprising plurality of processing modules, wherein the processing system uses the plurality of processing modules to process the data in the authorization request message in the second data format.

12. The gateway computer of claim 11, wherein the actions further comprise:
receiving the authorization request message in the second data format from the processing system;
converting the authorization request message in the second data format to the first data format; and
transmitting the authorization request message in the first data format to an authorizing entity computer.

13. The gateway computer of claim 12, wherein the actions further comprise:
generating processing module training data; and
sending the processing module training data to the processing system for augmenting the plurality of processing modules.

14. The gateway computer of claim 11, wherein the first data format is an ISO 8583 message format.

15. The gateway computer of claim 14, wherein the authorization request message is received from an access device via a transport computer.

16. A method of comprising:
receiving, by a processing system, from a gateway computer, an authorization request message in a second data format for an interaction, the authorization request message having been previously converted, by the gateway computer, from a first data format to the second data format; and
processing, by the processing system, data in the authorization request message in the second data format using a plurality of processing modules to include output data; and
transmitting, by the processing system, the authorization request message including the output data in the second data format.

17. The method of claim 16, wherein the first data format is an ISO 8583 data format.

18. The method of claim 16, wherein the method further comprises:
parsing the authorization request message in the first data format;
generating a plurality of transaction processing messages in data formats different than the first and second data formats; and
providing the plurality of transaction processing messages to the plurality of processing modules, respectively.

19. The method of claim 16, plurality of processing modules comprise security scoring module, an authentication module, and an interaction control module.

20. The method of claim 16, wherein the interaction is a transaction.
